(19) United States
(12) Patent Application Publication
(10) Pub. No.: US 2024/0393048 A1
(43) Pub. Date: Nov. 28, 2024

(54) DRYING APPARATUS

(71) Applicant: Guangdong KATOP Automation Co., Ltd., Zhaoqing (CN)

(72) Inventors: Gaowen ZHU, Zhaoqing (CN); Saiqiang YANG, Zhaoqing (CN); Ligen XING, Zhaoqing (CN); Lingxin YANG, Zhaoqing (CN); Zishuo JIANG, Zhaoqing (CN)

(21) Appl. No.: 18/663,398

(22) Filed: May 14, 2024

(30) Foreign Application Priority Data
May 24, 2023 (CN) 2023212858959

(51) Int. Cl. F26B 21/10; F26B 3/04; F26B 21/12; F26B 23/00

(52) U.S. Cl. CPC F26B 21/10; F26B 3/04; F26B 21/12; F26B 23/004

(57) ABSTRACT

Provided herein is a drying apparatus, which includes at least one oven and an external circulation system for providing hot air to the inside of the oven. The external circulation system includes a heating device, an air inlet duct and a linkage damper, wherein the air inlet duct comprises a high-temperature air duct and a low-temperature air duct, the outlets of which are connected to the oven through the linkage damper, and the inlets of which are communicated with the external air through a fan. The heating device is arranged on a pipeline of the high-temperature air duct, and an airflow ration of the high-temperature air duct to the low-temperature air duct can be controlled by adjusting the linkage damper. The oven can realize the temperature adjustment, and the adjustment is simple and results in high precision in temperature control.

### CROSS-REFERENCE TO RELATED APPLICATIONS

This application claims priority under 35 U.S.C. § 119(a) to Chinese Patent Application No. 2023212858959, filed on May 24, 2023, which is hereby incorporated by reference herein in its entirety.

### TECHNICAL FIELD

The disclosure relates to the field of lithium battery production, in particular to a drying apparatus.

### BACKGROUND ART

In the manufacturing process of lithium battery, electrode sheets and separators need to be heated and dried in a drying apparatus after coating. The electrode sheets and separators are dried by hot air in most of the existing drying apparatus. Fresh air, being drawn in by a fresh air blower, undergoes a heat exchange in a waste heat recovery heat exchanger and is heated by a heating element before being sent into a chamber inside an oven for a drying process. Eventually, the air is drawn out of the oven by an exhaust fan, and after a waste heat recovery and a follow-up treatment, it is released into the environment or reused in the circulation.

However, the energy structure varies by region, and is also affected by the site conditions. Some local manufacturers for the drying apparatus do not have the facilities for steam and heat transfer oil heating, and can only use electric heating, which requires higher power standards for distribution and wiring for the facilities and apparatus. Each oven in the drying apparatus may operate under different actual drying conditions, but all ovens are designed for the highest operating conditions, leading to an overall higher installed power capacity. Currently, the temperature of the oven can only be adjusted by controlling the output power of the heating element, which is not easy to adjust and the temperature control fluctuates greatly.

### SUMMARY

The present disclosure provides a drying apparatus, which comprises at least one oven and an external circulation system for providing hot air to the inside of the oven. By providing the external circulation system, an airflow ration of high-temperature air to low-temperature air can be adjusted through a linkage damper, thus enabling the temperature inside the oven to be adjusted. This adjustment is simple and results in high precision in temperature control. The apparatus adopts centralized heating for the whole system to reduce the installed power capacity; and it also allows for the selection of different heating methods to heat the oven, making it applicable in a wider range of scenarios.

The technical scheme adopted by the disclosure is as follows:

a drying apparatus comprises at least one oven and an external circulation system for providing hot air to the inside of the oven, wherein the external circulation system includes a heating device, an air duct and a linkage damper, and the air duct includes a high-temperature air duct and a low-temperature air duct, an outlet of the high-temperature air duct and an outlet of the low-temperature air duct are connected with the oven through the linkage damper, and an inlet of the high-temperature air duct and an inlet of the low-temperature air duct are communicated with an external air through a fresh air blower. The heating device is arranged on the pipeline of the high-temperature air duct, and can heat fresh air entering the high-temperature air duct, and an airflow ration of the high-temperature air duct to the low-temperature air duct can be controlled by adjusting the linkage damper, thereby regulating the mixed temperature of the high-temperature air and the low-temperature air.

According to an embodiment, the external circulation system further includes a waste heat recovery heat exchanger, an inlet of which is communicated with an outlet of the fresh air blower, and an outlet of which is communicated with the inlet of the high-temperature air duct and the inlet of the low-temperature air duct.

According to an embodiment, the oven includes an exhaust duct, which is communicated with the waste heat recovery heat exchanger and an exhaust fan, and the exhaust fan is used for exhausting an exhaust air that has undergone a heat exchange with a fresh air in the waste heat recovery heat exchanger to the external environment.

According to an embodiment, the drying apparatus further includes a filter, and the fresh air blower is communicated with the external air through the filter.

According to an embodiment, the exhaust duct, the high-temperature air duct and the low-temperature air duct are all provided with a temperature sensor and a pressure sensor, and the oven is internally provided with a temperature sensor and a pressure sensor, such that the temperature and pressure at all points are detected.

According to an embodiment, the external circulation system further includes a circulating fan, which is communicated with an outlet of the linkage damper, and can mix a mixed air at the outlet of the linkage damper with a return air inside the oven and transport it to a chamber inside the oven.

According to an embodiment, the oven includes an exhaust duct and a condenser, and an exhaust air from the exhaust duct is discharged to the condenser through the waste heat recovery heat exchanger, and then discharged to the external environment through the condenser or continues to participate in circulation.

According to an embodiment, an outlet of the condenser is communicated with an NMP recoverer, which in turn is communicated with the external environment.

According to an embodiment, the heating device adopts a U-shaped heating tube or a natural gas burner, and a front and a rear of the heating device are provided with a flame arrestor.

The disclosure has the following beneficial effects:
a. the drying apparatus, through the use of an external circulation system, replaces individual oven heating with centralized heating across multiple ovens. The power of the heating device can be designed according to the heat required for drying the entire line of ovens, which can greatly reduce the installed power capacity;
b. an airflow ration of the high-temperature air to the low-temperature air can be controlled by adjusting the linkage damper, and the temperature of the mixed air can be changed, thereby enabling the temperature within the oven to be adjusted. And such adjustment is simple and results in high precision in temperature control; and
c. since the hot air for each oven is heated centrally in the external circulation system, various heating modes such as heat transfer oil, steam, gas or electric heating can be selected to heat the hot air, bringing a wider application scenario.

### BRIEF DESCRIPTION OF THE DRAWINGS

The disclosure will be further explained with the attached drawings and embodiments.

FIG. 1 shows a schematic diagram according to a first embodiment of the disclosure;

FIG. 2 shows a schematic diagram of a linkage damper in the disclosure;

FIG. 3 shows a schematic diagram of multiple ovens sharing an external circulation system according to the first embodiment; and

FIG. 4 shows a schematic diagram according to a second embodiment of the disclosure.

### DETAILED DESCRIPTION

The concept, concrete structure and technical effects of this disclosure will be described clearly and completely with embodiments and drawings, so as to fully illustrate the purpose, characteristics and effects of this disclosure. Obviously, the described embodiment is only a part of the embodiment of the disclosure. Based on the embodiment of the disclosure, other embodiments obtained by those skilled in the art without paying creative labors belong to the protection scope of the disclosure. In addition, all the connection/connection relationships involved in the disclosure do not mean that the single-finger components are directly connected, but that a better connection structure can be formed by adding or reducing connection accessories according to the specific implementation situation. All technical features in the creation of the disclosure can be combined interactively without conflicting with each other.

### Embodiment 1

The disclosure provides a drying apparatus, which comprises an oven 2 and an external circulation system. The drying apparatus may be provided with one or more ovens 2, and one external circulation system can be shared by multiple ovens 2.

Referring to FIG. 1, it shows a schematic diagram of the connection between the oven and the external circulation system. The oven 2 is provided with an air inlet 20 and an air outlet 21, and the external circulation system is connected to the air inlet 20 and the air outlet 21.

The external circulation system includes a fresh air blower 24, a waste heat recovery heat exchanger 22, an air duct, a heating device 2220 and a linkage damper. An inlet of the fresh air blower 24 is connected to the external environment, and an outlet of the fresh air blower 24 is connected to an inlet of the waste heat recovery heat exchanger 22. The fresh air blower 24 draws air from the external environment and transports it to the waste heat recovery heat exchanger 22, and an outlet of the waste heat recovery heat exchanger 22 is connected to the air duct. The air duct includes a high-temperature air duct 222 and a low-temperature air duct 223. The heating device 2220 is arranged on a pipeline of the high-temperature air duct 222, and can heat the air within the high-temperature air duct 222. The outlet of the high-temperature air duct 222 and the outlet of the low-temperature air duct 223 are connected to the air inlet 20 of the oven 2 through the linkage damper. An exhaust air from the air outlet 21 of the oven 2 is collected at the waste heat recovery heat exchanger 22 through an exhaust duct 224, and is exhausted to the external environment through an exhaust fan 23 after the waste heat is recovered by the waste heat recovery heat exchanger 22.

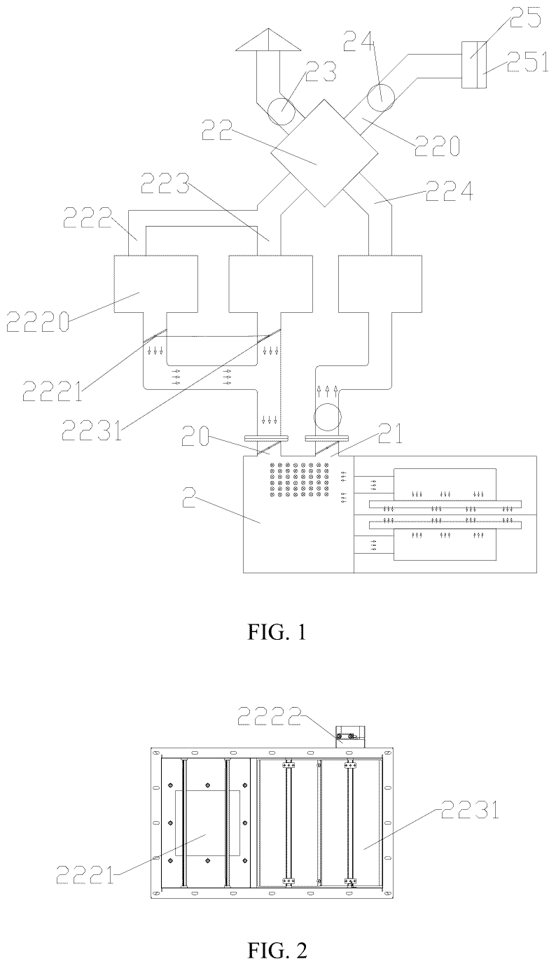

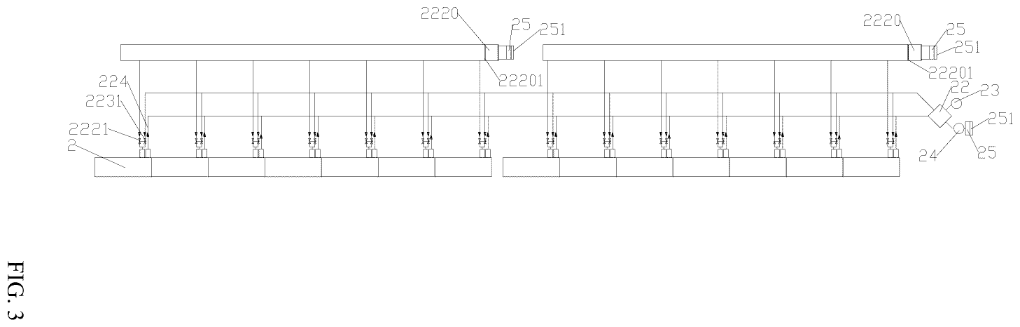

Referring to FIG. 2, the linkage damper is provided with a high-temperature damper 2221 communicating with the high-temperature air duct 222 and a low-temperature damper 2231 communicating with the low-temperature air duct 223. The opening degree of the high-temperature damper 2221 is inversely proportional to that of the low-temperature damper 2231. The linkage damper also includes an electric actuator 2222 for controlling the opening degree of the damper. The electric actuator 2222 is controlled by a program, and the opening degree of the linkage damper can be realized through electrical or mechanical linkage actions. The opening ratio of the high temperature damper 2221 and the low temperature damper 2231 is 1:−1, which is realized by the mechanical design of the damper itself. That is to say, when the high temperature damper 2221 is fully opened, the low temperature damper 2231 is fully closed, and then the electric actuator automatically controls the opening degree through the program.

The exhaust duct 224, the high-temperature air duct 222 and the low-temperature air duct 223 are all provided with a temperature sensor and a pressure sensor, and the oven is also provided with a temperature sensor and a pressure sensor inside, such that the temperature and pressure at various points can be detected.

When there is a need to heat up the oven, that is, when the set temperature of the oven is higher than the temperature detected by the temperature sensor, the high-temperature damper 2221 is automatically controlled to open gradually by the program, and can be fully opened to the maximum. When the actual detected temperature is close to the set temperature, the high temperature damper 2221 is closed slowly until the actually detected temperature is equal to the set temperature, at which point its opening degree is fixed and no longer adjusted. When the oven needs to be cooled, that is, when the set temperature of the oven is lower than the actual detected temperature, the adjustment process is opposite to the heating process. By designing the linkage damper, the temperature of the oven can be adjusted more quickly.

In this embodiment, the oven is a negative electrode oven, and the heating device 2220 is heated by gas, and a flame arrestor is arranged at the front and rear of the heating device 2220 to improve the safety during operation.

A filter is arranged in front of an inlet of the fresh air blower 24, where air will be filtered before being drawn to the air duct by the fresh air blower 24. The filter includes a primary filter 251 and a medium-efficiency filter 25. After being filtered, the air is then conveyed by the fresh air blower 24 to the waste heat recovery heat exchanger 22 to undergo heat exchange with the exhaust air from the oven 2. The waste heat recovery heat exchanger 22 is connected with the exhaust fan 23, and all the exhaust air after heat exchange is discharged to the external environment through the exhaust fan 23.

Referring to FIG. 3, it shows a schematic diagram of multiple oven sharing one external circulation system in the drying apparatus. The drying apparatus is divided into two modules, each including seven ovens. Each module is provided with a natural gas burner 2220 as a heating device, which is responsible for the heating work of the seven ovens in the module. The drying apparatus adopts centralized heating, and one natural gas burner 2220 can provide the heat required for drying for multiple ovens, which can effectively reduce the installed power of the whole apparatus. Moreover, the high energy conversion rate of natural gas can reduce the overall energy consumption of the apparatus.

The work flow of the drying apparatus according to the disclosure is as follows. The fresh air, after being filtered, is transported to the waste heat recovery heat exchanger 22 by the fresh air blower 24, and the fresh air in the waste heat recovery heat exchanger 22 exchanges heat with the exhaust air from the oven 2. The waste heat recovery heat exchanger 22 then transports the heat-exchanged low-temperature air to the high-temperature air duct 222 and the low-temperature air duct 223. A burner 2220 is arranged on the pipeline of the high-temperature air duct 222, and the burner 2220 releases heat by burning natural gas to heat the low-temperature air in the high-temperature air duct 222. The heated high-temperature air from the high-temperature air duct 222 and the low-temperature air from the low-temperature air duct 223 are mixed together once through the high-temperature air damper 2221 and the low-temperature air damper 2231 of the linkage air damper to form a total fresh air, which is then sent into the oven 2 by the circulating fan. The total fresh air is mixed with the return air from the oven 2 for a second time to form as a circulating air, which is conveyed to the chamber of the oven 2 by the circulating fan and then blown out by an air nozzle.

### Embodiment 2

The difference between Embodiment 2 and Embodiment 1 is that the oven in this embodiment is a positive electrode oven, and the heating device adopts a U-shaped electric heating tube. In practical application, other heating methods such as heat transfer oil or steam can be selected according to the needs of the scenario, making it applicable in a wider range of scenarios. By designing an electric heating device with a higher energy conversion rate, the air that has been treated after waste heat recovery is directly heated, reducing the output power of the heating device and minimizing energy loss. The apparatus uses a centralized heating method, which can lower the overall power consumption of the apparatus.

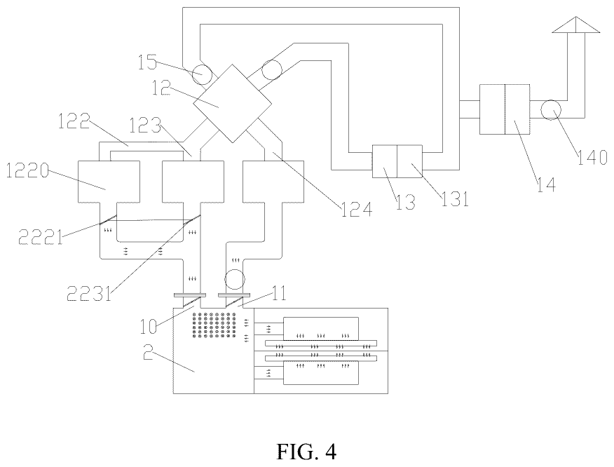

Referring to FIG. 4, the exhaust air from the positive electrode oven contains a high concentration of N-Methylpyrrolidone (NMP), and in this embodiment, the U-shaped heating tube 1220 is provided with a flame arrestor in front and rear to prevent NMP from burning and exploding. In addition, in this embodiment, a condenser and an NMP recoverer 14 are also provided to reduce the NMP vapor in the exhaust air, avoiding explosions at the heating device 1220 due to the high concentration of NMP. The exhaust outlet 11 of the oven 2 transports the exhaust air to the waste heat recovery heat exchanger 12 through the exhaust duct 124 for heat exchange and cooling, and then to the condenser. The condenser includes a chilled water condenser 13 and a cooling water condenser 131 for cooling the exhaust air to produce an exhaust air with a low-concentration of NMP. The exhaust air with high-temperature and a high-concentration of NMP in the oven 2 is converted into an exhaust air with low-temperature and a low-concentration of NMP after a secondary cooling treatment by the waste heat recovery heat exchanger 12 and the condenser. A portion of the exhaust air, between 4% to 10%, is treated by the NMP recoverer 14 to meet emission standards before being discharged to the external environment by the exhaust fan 140, while the remaining exhaust air is drawn by a fresh air blower 15 to the waste heat recovery heat exchanger 12 to undergo heat exchange with the exhaust air with high-temperature and a high-concentration of NMP, becoming an exhaust air with a low-temperature to continue to reuse in the circulation.

The low-temperature air that has undergone heated exchange in the waste heat recovery heat exchanger 12 flows to the high-temperature air duct 122 and the low-temperature air duct 123. The low-temperature air passing through the high-temperature air duct 122 becomes a high-temperature air after being heated by the U-shaped heating tube 1220. The volume of low-temperature air passing through the low-temperature air duct 123 and the volume of high-temperature air passing through the high-temperature air duct 122 can be controlled by the high-temperature air damper 2221 and the low-temperature air damper 2231, which are finally mixed to form a fresh air that flows through the air inlet 10 into the oven 2.

There is a circulating fan arranged at the air inlet of the oven, and the air output through the linkage damper and the return air inside the oven can be mixed again to form a circulating air, which is transported to the chamber of the oven through the circulating fan and then blown out by an air nozzle.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

What is claimed is:

1. A drying apparatus, comprising at least one oven and an external circulation system for providing hot air to the inside of the oven,
wherein the external circulation system includes a heating device, an air duct and a linkage damper;
wherein the air duct includes a high-temperature air duct and a low-temperature air duct, an outlet of the high-temperature air duct and an outlet of the low-temperature air duct are connected with the oven through the linkage damper, and an inlet of the high-temperature air duct and an inlet of the low-temperature air duct are communicated with external air through a fresh air blower; and
wherein the heating device is arranged on a pipeline of the high-temperature air duct to heat fresh air entering the high-temperature air duct, and an airflow ration of the high-temperature air duct to the low-temperature air duct is controlled by adjusting the linkage damper, thereby regulating a mixing temperature of the high-temperature air and the low-temperature air.

2. The drying apparatus according to claim 1, wherein the external circulation system further includes a waste heat recovery heat exchanger, an inlet of which is communicated with an outlet of the fresh air blower, and an outlet of which is communicated with the inlet of the high-temperature air duct and the inlet of the low-temperature air duct.

3. The drying apparatus according to claim 2, wherein the oven includes an exhaust duct, which is communicated with the waste heat recovery heat exchanger and an exhaust fan, and the exhaust fan is used for exhausting an exhaust air that has undergone a heat exchange with the fresh air in the waste heat recovery heat exchanger to an external environment.

4. The drying apparatus according to claim 2, further comprising a filter, wherein the fresh air blower is communicated with the external air through the filter.

5. The drying apparatus according to claim 3, wherein the exhaust duct, the high-temperature air duct and the low-temperature air duct are provided with a temperature sensor and a pressure sensor, and the oven is internally provided with a temperature sensor and a pressure sensor, such that temperature and pressure at all points are detected.

6. The drying apparatus according to claim 1, wherein the external circulation system further includes a circulation fan, which is communicated with an outlet of the linkage damper, and mixes a mixed air at the outlet of the linkage damper with a return air inside the oven and transport it to a chamber inside the oven.

7. The drying apparatus according to claim 2, wherein the oven comprises an exhaust duct and a condenser, and an exhaust air from the exhaust duct is discharged to the condenser through the waste heat recovery heat exchanger, and then discharged to the external environment through the condenser or continues to participate in circulation.

8. The drying apparatus according to claim 7, wherein an outlet of the condenser is communicated with an NMP recoverer, which in turn is communicated with the external environment.

9. The drying apparatus according to claim 7, wherein the heating device adopts a U-shaped heating tube or a natural gas burner, and a front and a rear of the heating device are provided with a flame arrestor.
